(19) United States
(12) Patent Application Publication
(10) Pub. No.: US 2014/0205020 A1
(43) Pub. Date: Jul. 24, 2014

(54) REAL-TIME TRANSCODING METHOD AND DEVICE

(71) Applicant: HUAWEI TECHNOLOGIES CO., LTD., Shenzhen (CN)

(72) Inventor: Shuai LOU, Beijing (CN)

(73) Assignee: HUAWEI TECHNOLOGIES CO., LTD., Shenzhen (CN)

(21) Appl. No.: 14/107,342

(22) Filed: Dec. 16, 2013

Related U.S. Application Data
(63) Continuation of application No. PCT/CN2011/083519, filed on Dec. 6, 2011.

(51) Int. Cl. H04N 19/127; H04N 19/152; H04N 19/40

(52) U.S. Cl. CPC H04N 19/00103; H04N 19/00472; H04N 19/00193
USPC 375/240.26

(57) ABSTRACT

The present invention provides a real-time transcoding method and device. The transcoding device obtains the current first transcoding speed, and adjusts the transcoding parameter according to the first transcoding speed and the preset second transcoding speed so as to perform real-time conversion for the media stream by using the adjusted transcoding parameter, which solves the problem that the real-time transcoding flexibility is reduced because the transcoding device uses a fixed transcoding parameter to perform real-time conversion for the media stream in the prior art.

### CROSS-REFERENCE TO RELATED APPLICATIONS

This application is a continuation of International Application No. PCT/CN2011/083519, filed on Dec. 6, 2011, which is hereby incorporated by reference in its entirety.

### TECHNICAL FIELD

The present invention relates to a real-time transcoding technology, and in particular, to a real-time transcoding method and device.

### BACKGROUND

Streaming media refer to multimedia content, such as audio and video, that is transmitted in real time in the form of a data stream, and the streaming technology is a technology of using, processing, and publishing a multimedia data stream (a media stream) on a network. The real-time transcoding technology of a media stream is important in the streaming technology. In the prior art, the real-time transcoding is generally to convert a media stream in real time by using a preset fixed transcoding parameter so that the transcoded media stream is suitable for a specific media service.

However, scenarios of multimedia content are miscellaneous, and the transcoding speed is subject to the media content. If a fixed transcoding parameter is used to perform real-time transcoding for a media stream, flexibility of the real-time transcoding will be reduced. For example, if the fixed transcoding parameter does not meet the transcoding real-timeness required by a current multimedia scenario, the data input into a buffer will overflow, which leads to unsmooth video play, blocking effect, and another consequence on the client and affects quality of a streaming service; and, if the fixed transcoding parameter excessively meets the transcoding real-timeness required by the current multimedia scenario, a waste of a system resource may occur.

### SUMMARY

Embodiments of the present invention provide a real-time transcoding method and device to solve a problem that real-time transcoding flexibility is reduced because the transcoding device uses a fixed transcoding parameter to perform real-time conversion for a media stream in the prior art.

In one aspect, a real-time transcoding method is provided, including:
obtaining, by a transcoding device, a current first transcoding speed; adjusting, by the transcoding device, a transcoding parameter according to the first transcoding speed and a preset second transcoding speed; and
performing, by the transcoding device, real-time conversion for a media stream by using the adjusted transcoding parameter.

In another aspect, a real-time transcoding device is provided, including:
an obtaining unit, configured to obtain a current first transcoding speed;
an adjusting unit, configured to adjust a transcoding parameter according to the first transcoding speed and a preset second transcoding speed; and
a transcoding unit, configured to perform real-time conversion for a media stream by using the adjusted transcoding parameter.

As seen from the above technical solutions, the transcoding device obtains the current first transcoding speed, and adjusts the transcoding parameter according to the first transcoding speed and the preset second transcoding speed so as to perform real-time conversion for the media stream by using the adjusted transcoding parameter, which solves the problem that the real-time transcoding flexibility is reduced because the transcoding device uses a fixed transcoding parameter to perform real-time conversion for the media stream in the prior art. If the current transcoding parameter does not fulfill the transcoding real-timeness required by the current multimedia scenario, the transcoding device may adjust the transcoding parameter properly so that the adjusted transcoding parameter can fulfill the transcoding real-timeness required by the current multimedia scenario, which avoids unsmooth video play, blocking effect, and another consequence on the client caused by an overflow of the data input into the buffer, and improves quality of the streaming service. If the current transcoding parameter fulfills the transcoding real-timeness required by the current multimedia scenario, the transcoding device may adjust the transcoding parameter properly to reduce a transcoding speed corresponding to the adjusted transcoding parameter, which improves audio or video quality corresponding to the current multimedia scenario and makes full use of a system resource.

### BRIEF DESCRIPTION OF DRAWINGS

To illustrate the technical solutions in the embodiments of the present invention more clearly, the following briefly introduces the accompanying drawings required for describing the embodiments . Apparently, the accompanying drawings in the following description show merely some embodiments of the present invention, and a person of ordinary skill in the art may still derive other drawings from these accompanying drawings without creative efforts.

FIG. 1 is a schematic flowchart of a real-time transcoding method according to an embodiment of the present invention; and

FIG. 2 is a schematic structural diagram of a real-time transcoding device according to another embodiment of the present invention.

### DESCRIPTION OF EMBODIMENTS

To make the objectives, technical solutions, and advantages of the embodiments of the present invention more comprehensible, the following clearly describes the technical solutions in the embodiments of the present invention with reference to the accompanying drawings in the embodiments of the present invention. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

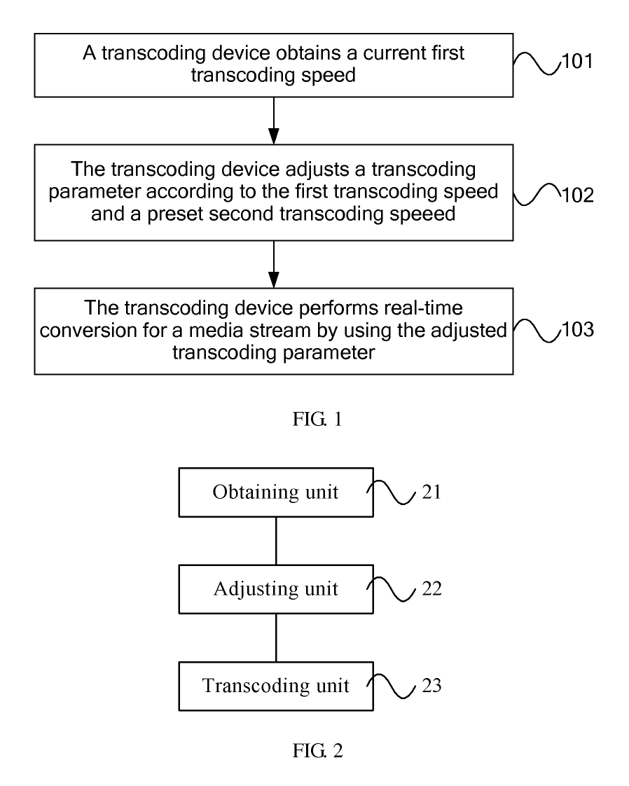

FIG. 1 is a schematic flowchart of a real-time transcoding method according to an embodiment of the present invention. As shown in FIG. 1, the real-time transcoding method in the embodiment may include the following steps:

101. A transcoding device obtains a current first transcoding speed.

For example, the transcoding device may obtain the current first transcoding speed according to the number of frames that are transrated in real time within a specific time.

Optionally, before 101, the transcoding device may further perform real-time conversion for the media stream by using a preset initial transcoding parameter so that the transcoding device performs 101 to obtain the current first transcoding speed.

102. The transcoding device adjusts a transcoding parameter according to the first transcoding speed and a preset second transcoding speed.

For example, if the first transcoding speed is less than the preset second transcoding speed, it indicates that the current transcoding parameter does not fulfill the transcoding real-timeness required by the current multimedia scenario, and the transcoding parameter may be adjusted properly so that the adjusted transcoding parameter can fulfill the transcoding real-timeness required by the current multimedia scenario.

For example, if the first transcoding speed is greater than or equal to the preset second transcoding speed, it indicates that the current transcoding parameter fulfills the transcoding real-timeness required by the current multimedia scenario, and the transcoding parameter may be adjusted properly to reduce a transcoding speed corresponding to the adjusted transcoding parameter, which improves audio or video quality corresponding to the current multimedia scenario.

Optionally, the transcoding device may adjust the transcoding parameter according to a preset standard transcoding parameter, a preset second transcoding speed, and the first transcoding speed so that a transcoding speed corresponding to the adjusted transcoding parameter is greater than or equal to a transcoding speed corresponding to the preset standard transcoding parameter.

For example, if the first transcoding speed is greater than or equal to the preset second transcoding speed, it indicates that the current transcoding parameter fulfills the transcoding real-timeness required by the current multimedia scenario, and the transcoding parameter may be adjusted properly so that a transcoding speed corresponding to the adjusted transcoding parameter decreases to a transcoding speed corresponding to the preset standard transcoding parameter as far as possible, which improves audio or video quality corresponding to the current multimedia scenario properly while definitely ensuring the real-timeness of the real-time conversion.

103. The transcoding device performs real-time conversion for a media stream by using the adjusted transcoding parameter.

It should be noted that the real-time transcoding method provided in the embodiment of the present invention is applicable to any coding format, on which the embodiment of the present invention places no limitation. For example, a target coding format of the real-time conversion is H.264, and therefore, the transcoding device may adjust at least one of parameters according to the preset second transcoding speed and the first transcoding speed, where the parameters include but are not limited to: motion vector search algorithm (such as full search algorithm and hexagon search algorithm), motion vector search range, P-frame fast skip decision mode (for example, enabled or disabled), number of reference frames, and usage of trellis coding (for example, enabled or disabled).

It can be understood that, before 102, a series of adjustment transcoding parameter sets of different transcoding speeds may be preset, and therefore, in 102, different parameter sets can be selected according to the preset second transcoding speed and the first transcoding speed to implement fast adjustment of the transcoding parameter.

In this embodiment, the transcoding device obtains the current first transcoding speed, and adjusts the transcoding parameter according to the first transcoding speed and the preset second transcoding speed so as to perform real-time conversion for the media stream by using the adjusted transcoding parameter, which solves the problem that the real-time transcoding flexibility is reduced because the transcoding device uses a fixed transcoding parameter to perform real-time conversion for the media stream in the prior art. If the current transcoding parameter does not fulfill the transcoding real-timeness required by the current multimedia scenario, the transcoding device may adjust the transcoding parameter properly so that the adjusted transcoding parameter can fulfill the transcoding real-timeness required by the current multimedia scenario, which avoids unsmooth video play, blocking effect, and another consequence on the client caused by an overflow of the data input into the buffer, and improves quality of the streaming service. If the current transcoding parameter fulfills the transcoding real-timeness required by the current multimedia scenario, the transcoding device may adjust the transcoding parameter properly to reduce a transcoding speed corresponding to the adjusted transcoding parameter, which improves audio or video quality corresponding to the current multimedia scenario and makes full use of a system resource.

It should be noted that, for brevity, the above method embodiments are represented as a series of actions. But those skilled in the art should appreciate that the present invention is not limited to the order of the described actions, because according to the present invention, some steps may adopt other order or occur simultaneously. It should be further understood by persons skilled in the art that the described embodiments are all exemplary embodiments, and the involved actions and modules are not necessarily required by the present invention.

In the above embodiments, the description of each embodiment has its emphasis, and some embodiments may not be detailed. Reference may be made to the relevant description of other embodiments.

FIG. 2 is a schematic structural diagram of a real-time transcoding device according to another embodiment of the present invention. As shown in FIG. 2, the real-time transcoding device in this embodiment may include an obtaining unit 21, an adjusting unit 22, and a transcoding unit 23. The obtaining unit 21 is configured to obtain a current first transcoding speed. The adjusting unit 22 is configured to adjust a transcoding parameter according to the first transcoding speed obtained by the obtaining unit 21 and a preset second transcoding speed. The transcoding unit 23 is configured to perform real-time conversion for a media stream by using the transcoding parameter adjusted by the adjusting unit 22.

The functions of the transcoding device in the embodiment corresponding to FIG. 1 may be implemented by the real-time transcoding device provided in this embodiment.

Optionally, the transcoding unit 23 in this embodiment may further perform real-time conversion for the media stream by using a preset initial transcoding parameter so that the obtaining unit 21 obtains the current first transcoding speed.

For example, the obtaining unit 21 in this embodiment may obtain the current first transcoding speed according to the number of frames that are transrated by the transcoding unit 23 in real time within a specific time.

It should be noted that the real-time transcoding device provided in the embodiment of the present invention is applicable to any coding format, on which the embodiment of the present invention places no limitation. For example, a target coding format of the real-time conversion is H.264, and therefore, the adjusting unit 22 in this embodiment may adjust at least one of parameters according to the preset second transcoding speed and the first transcoding speed, where the parameters include but are not limited to: motion vector search algorithm, motion vector search range, P-frame fast skip decision mode, number of reference frames, and usage of trellis coding.

Further, the adjusting unit 22 in this embodiment may further adjust the transcoding parameter according to a preset standard transcoding parameter, a preset second transcoding speed, and the first transcoding speed so that a transcoding speed corresponding to the adjusted transcoding parameter is greater than or equal to a transcoding speed corresponding to the preset standard transcoding parameter.

In this embodiment, the transcoding device uses the obtaining unit to obtain the current first transcoding speed, and the adjusting unit adjusts the transcoding parameter according to the preset second transcoding speed and the first transcoding speed obtained by the obtaining unit, and therefore, the transcoding unit can perform real-time conversion for the media stream by using the transcoding parameter adjusted by the adjusting unit, which solves the problem that the real-time transcoding flexibility is reduced because the transcoding device uses a fixed transcoding parameter to perform real-time conversion for the media stream in the prior art. If the current transcoding parameter does not fulfill the transcoding real-timeness required by the current multimedia scenario, the transcoding device may adjust the transcoding parameter properly so that the adjusted transcoding parameter can fulfill the transcoding real-timeness required by the current multimedia scenario, which avoids unsmooth video play, blocking effect, and another consequence on the client caused by an overflow of the data input into the buffer, and improves quality of the streaming service. If the current transcoding parameter fulfills the transcoding real-timeness required by the current multimedia scenario, the transcoding device may adjust the transcoding parameter properly to reduce a transcoding speed corresponding to the adjusted transcoding parameter, which improves audio or video quality corresponding to the current multimedia scenario and makes full use of a system resource.

It may be clearly understood by a person skilled in the art that, for the purpose of convenient and brief description, a detailed working process of the foregoing system, apparatus, and unit, reference may be made to the corresponding process in the foregoing method embodiments, and the details will not be described herein again.

In the several embodiments provided in the present application, it should be understood that the disclosed system, apparatus, and method may be implemented in another manner. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. A part or all of the units may be selected according to actual needs to achieve the objectives of the solutions of the embodiments.

In addition, functional units in the embodiments of the present invention may be integrated into one processing unit, or each of the units may exist alone physically, or two or more units are integrated into one unit. The integrated units may be implemented in a form of hardware, or may also be implemented in a form of hardware plus a software functional unit.

The integrated unit implemented in a form of software functional unit may be stored in a computer readable storage medium. The software functional unit is stored in a storage medium and includes several instructions for instructing a computer device (which may be a personal computer, a server, or a network device) to perform part of the steps of the methods in the embodiments of the present invention. The foregoing storage medium includes: any medium that can store program codes, such as a USB flash disk, a removable hard disk, a read-only memory (Read-Only Memory, ROM), a random access memory (Random Access Memory, RAM), a magnetic disk, or an optical disk.

Finally, it should be noted that the foregoing embodiments are merely intended for describing the technical solutions of the present invention, rather than limiting the present invention. Although the present invention is described in detail with reference to the foregoing embodiments, a person of ordinary skill in the art should understand that he may still make modifications to the technical solutions described in the foregoing embodiments, or make equivalent replacements to some technical features thereof, without departing from the spirit and scope of the technical solutions of the embodiments of the present invention.

1. A real-time transcoding method, comprising:
obtaining, by a transcoding device, a current first transcoding speed;
adjusting, by the transcoding device, a transcoding parameter according to the first transcoding speed and a preset second transcoding speed; and
performing, by the transcoding device, real-time conversion for a media stream by using the adjusted transcoding parameter.

2. The method according to claim 1, wherein before the obtaining, by a transcoding device, a current first transcoding speed, further comprising:
performing, by the transcoding device, real-time conversion for the media stream by using a preset initial transcoding parameter so that the transcoding device obtains the current first transcoding speed.

3. The method according to claim 1, wherein the obtaining, by a transcoding device, a current first transcoding speed comprises:
obtaining, by the transcoding device, the current first transcoding speed according to the number of frames that are transrated in real time within a specific time.

4. The method according to claim 1 , wherein a target coding format of the real-time conversion is H.264, and the adjusting, by the transcoding device, a transcoding parameter according to the first transcoding speed and a preset second transcoding speed comprises:
adjusting, by the transcoding device, at least one of parameters according to the first transcoding speed and the preset second transcoding speed, wherein the parameters are motion vector search algorithm, motion vector search range, P-frame fast skip decision mode, number of reference frames, and usage of trellis coding.

5. The method according to claim 1, wherein the adjusting, by the transcoding device, a transcoding parameter according to the first transcoding speed and a preset second transcoding speed comprises:
adjusting, by the transcoding device, the transcoding parameter according to the first transcoding speed, a preset standard transcoding parameter, and the preset second transcoding speed so that a transcoding speed corresponding to the adjusted transcoding parameter is greater than or equal to a transcoding speed corresponding to the preset standard transcoding parameter.

6. A real-time transcoding device, comprising:
an obtaining unit, configured to obtain a current first transcoding speed;
an adjusting unit, configured to adjust a transcoding parameter according to the first transcoding speed and a preset second transcoding speed; and
a transcoding unit, configured to perform real-time conversion for a media stream by using the adjusted transcoding parameter.

7. The device according to claim 6, wherein the transcoding unit is further configured to:
perform real-time conversion for the media stream by using a preset initial transcoding parameter so that the obtaining unit obtains the current first transcoding speed.

8. The device according to claim 6, wherein the obtaining unit is specifically configured to:
obtain the current first transcoding speed according to the number of frames that are transrated by the transcoding unit in real time within a specific time.

9. The device according to claim 6 , wherein a target coding format of the real-time conversion is H.264, and the adjusting unit is specifically configured to:
adjust at least one of parameters according to the first transcoding speed and the preset second transcoding speed, wherein the parameters are motion vector search algorithm, motion vector search range, P-frame fast skip decision mode, number of reference frames, and usage of trellis coding.

10. The device according to claim 6, wherein the adjusting unit is specifically configured to:
adjust the transcoding parameter according to the first transcoding speed, a preset standard transcoding parameter, and the preset second transcoding speed so that a transcoding speed corresponding to the adjusted transcoding parameter is greater than or equal to a transcoding speed corresponding to the preset standard transcoding parameter.

11. An apparatus comprising:
a real-time transcoding device configured to obtain a current first transcoding speed, to adjust a transcoding parameter according to the first transcoding speed and a preset second transcoding speed, and to perform real-time conversion for a media stream by using the adjusted transcoding parameter.
